(19) United States
(12) Patent Application Publication
(10) Pub. No.: US 2018/0311670 A1
(43) Pub. Date: Nov. 1, 2018

(54) FLUIDIC PATH SEALING AND CUTTING DEVICE

(71) Applicant: Biocartis NV, Mechelen (BE)

(72) Inventors: Nicolas Vergauwe, Mechelen (BE); Frederik Doucet, Mechelen (BE); Thierry Tollenboom, Mechelen (BE)

(73) Assignee: Biocartis NV, Mechelen (BE)

(21) Appl. No.: 15/772,162

(22) PCT Filed: Nov. 30, 2016
(86) PCT No.: PCT/EP2016/079308

§ 371 Date: Apr. 30, 2018

(30) Foreign Application Priority Data
Nov. 30, 2015 (EP) 15197156.1

(51) Int. Cl. B01L 3/00

(52) U.S. Cl. CPC B01L 3/502715; B01L 3/565; B01L 2400/0677; B01L 2200/0689; B01L 2300/0816; B01L 2200/027

(57) ABSTRACT

A device for sealing liquids inside a selected zone of a fluidic path that runs in a fluidic assembly and then for cutting or removing the thus sealed zone in a spillage- and contamination-free manner from said fluidic assembly. Methods of performing such contamination- and leakage-free sealing and cutting of selected fluidic path zones comprising a liquid of interest from the remaining parts of fluidic assemblies, preferably in a fully automated manner.

### TECHNICAL FIELD

The present disclosure relates to a device for sealing of liquids inside of a selected zone within a fluidic path that runs in a larger fluidic assembly, and for subsequent cutting out of said thus sealed fluidic path zone from said fluidic assembly in a spillage- and contamination-free manner. In a further aspect, the present disclosure also concerns methods of performing such spillage- and contamination-free sealing and cutting of the selected fluidic path zones comprising liquids of interest from remaining parts of fluidic assemblies.

### BACKGROUND OF THE INVENTION

Diagnostic market is currently experiencing a rapid increase in automated and semi-automated assays for detection of genetic information of interest, which aim at reducing the handling of clinical samples by specially-trained personnel. Such assays usually involve DNA amplification and take form of fluidic assemblies having a number of specialized compartments (e.g. channels or chambers) arranged along at least one fluidic path. These compartments are configured to perform different sample processing steps on a liquid sample as it passes along the fluidic path until reaching the final compartment or compartments wherein the DNA amplification is performed. A good example of such assembly is a diagnostic cartridge developed by Biocartis NV, which offers full sample-to-result processing with minimal manual handling, high user-friendliness, and advanced e-connectivity.

In any of the DNA-amplification-based diagnostic techniques, effective prevention of contamination, cross-contamination, or accidental release of highly amplified DNA material to the laboratory environment where such tests are routinely performed, is a key consideration to ensure high specificity of diagnostic assays. For this and other reasons, diagnostic fluidic assemblies like cartridges are often provided as self-contained and hermetically closed systems which are meant to be disposed of, frequently in one piece, once the contained therein assay was run.

One of the most common features of clinical samples is that they are very limited in their availability and amount. However, in line with the stringent contamination prevention policy, diagnostic fluidic assemblies generally do not provide an easy access to the introduced therein clinical sample or its final processed or amplified product in case a diagnostic follow-up of the patient would be desired. Furthermore, often it is usually not immediately known if such follow up will be needed, and, if yes, will it require sending to another differently specialized facility of whatever could be retrieved from what is still remaining of the already limited clinical sample.

The decision to retest a biological sample or its amplification products, e.g. via sequencing, may take months or even years. For this reason, many diagnostic laboratories may consider freezing and storing the whole fluidic assemblies to secure the biological material contained therein till it becomes clear if its valuable contents are to be retested or sent to an appropriate facility.

Storage of biological samples in entire fluidic assemblies such as cartridges, however poses several problems. Firstly, because in such assemblies the different compartments for processing a biological sample are arranged along one fluidic path, and therefore, are in fluid connection with one another, once such assembly is detached from the apparatus that drives pumping and positioning of the contained therein liquids, the liquid of interest may over time escape from its compartment via e.g. capillary forces. One way of counteracting this, would be to freeze the fluidic assembly to be stored together with its liquid contents. Freezing of biological samples is a routine procedure for preventing their degradation. However, bringing a bulky, air-filled, multi-chamber, and multilayer fluidic assembly below certain temperature takes much more time in a standard −20° C. freezer than e.g. a regular laboratory tube where freezing of its liquid contents through direct conduction by the tube wall happens more rapidly. Therefore, depending on the internal complexity of a fluidic assembly, freezing its contents for storage is likely to take too long to fully prevent the displacement or even degradation of the biological material of interest within the assembly.

For the above reasons, there exists a need for providing means that will lock the precious liquid contents within a defined part of a fluidic path inside of the assembly, thus preventing it from displacing from that part along this fluidic path, reducing potential evaporation-related issues, and also enabling the sample's future much easier retrieval. Furthermore, storing large quantities of rather bulky fluidic assemblies in energy-consuming freezers over prolonged periods is not cost-effective and many laboratories cannot afford to arrange sufficient storage space. Therefore, it would further be advantageous to also provide means for spillage- and contamination-free removal of the locked fluidic path parts containing the liquid of interest from the no longer needed remaining bulk of such fluidic assemblies. Like this, only the much smaller part from the initial assembly, which effectively contains the liquid of interest, could be stored. Such solution would not only afford for saving on storage costs but also for decreasing the time needed for bringing the liquid of interest below its freezing point, thus contributing to better preservation of the biological material's stability.

As majority of current disposable diagnostic fluidic and microfluidic assemblies are made of plastics, the present invention addresses the above listed needs by providing a device for sealing the selected fluidic path part of choice, firstly using a plastic melting action, and then providing a cutting action to cut through the zone sealed by the thus molten plastic, such that the sealed fluidic part of choice is separated from the reminder of the fluidic assembly. In a preferred embodiment, the device of the invention is configured to access the part to be sealed and provide a localized heating to melt the thermoplastic material around this part, and by doing so seal the chosen zone away from other parts of the fluidic assembly. In a preferred embodiment, the provided herein device further provides means for removing the sealed and cut fluidic path zone from the reminder of the fluidic assembly. In this manner, the presented herein device serves the purpose of locking and securing a liquid of choice within a limited part of a fluidic path that belongs to a larger assembly and then recovering said part containing said liquid from this larger assembly without risking liquid spills.

To our best knowledge, no devices are known in the art that would be suitable for specifically accessing, sealing, and removing in a contamination-free manner the chosen fluid-containing part of a duct belonging to a longer fluidic path in fluidic or microfluidic assemblies. In particular, no such devices are known that not only are capable of sealing a part of a fluidic path but also can disconnect and remove it from the reaming bulk of the fluidic assembly in a spillage-free manner. Devices that can seal a thermoplastic substrate and possibly cut through it were described e.g. in U.S. Pat. No. 3,083,757, teaching a knife sealer for a thermoplastic film or sheet, or in U.S. Pat. No. 5,056,295 describing a cutter and sealer for film. None of these known devices were shown to seal and cut through stiff thermoplastic and often composite ducts or channels containing liquid material in a spillage- and contamination-free manner. Furthermore, none of them is suitable to manipulate sophisticated fluidic assemblies to access the specific ducts of interest and ensure their contamination-free disconnecting such that a portion of a liquid is reliably locked and retained inside of the removed part.

Thus, the present invention provides unique means for melting and cutting through a stiff thermoplastic substrate, possibly being a composite, in which fluidic channels are formed. As a consequence, the device of the present invention requires much more sophistication than the afore-mentioned sealing-and-cutting devices for thin and flexible films, as it has to selectively provide elevated temperatures to well defined zones of a given fluidic path, and possibly also perform an additional well-controlled pressing and/or cutting action in order to separate the molten channel part in two. These and other features and advantages of the present invention will be presented in continuation.

### SUMMARY OF THE INVENTION

The present invention is defined in the appended independent claims. Preferred embodiments are defined in the dependent claims. In particular, the present invention concerns a device for sealing and cutting through a fluidic path in a fluidic assembly, preferably being a closed fluidic assembly, said device comprising:
a manipulation compartment for holding a fluidic assembly comprising at least one fluidic channel forming a path for fluidic flow and comprising a thermoplastic zone, further referred to as a thermoplastic fluidic channel zone, comprising a thermoplastic material meltable when exposed to a temperature equal or above a threshold temperature specific to said thermoplastic material; and
a heating element positioned in or capable of entering into the manipulation compartment and capable of producing temperature equal to or above said threshold temperature;
   wherein said device is configured such that when the fluidic assembly is provided in the manipulation compartment, the heating element accesses and heats at least a part of the thermoplastic fluidic channel zone for a time sufficient to melt the thermoplastic material comprised in said heated part and to seal the fluidic channel by the thus molten thermoplastic materia; the device being characterized in that the device comprises a cutting element configured to cut the sealed fluidic channel within the molten thermoplastic material.

Finally, the present invention also provides a method for sealing and cutting through a fluidic path in a fluidic assembly comprising at least one fluidic channel forming a path for fluidic flow and comprising a thermoplastic zone, further referred to as a thermoplastic fluidic channel zone, comprising a thermoplastic material meltable when exposed to a temperature equal or above a threshold temperature specific to said thermoplastic material, said method comprising the steps of:
providing the fluidic assembly;
providing a heating element capable of producing temperature equal to or above the threshold temperature specific to thermoplastic material comprised in the thermoplastic fluidic channel zone; and
providing a localized heating from the heating element to at least a part of the thermoplastic fluidic channel zone for a time sufficient to melt the thermoplastic material comprised in said heated part and to seal said fluidic channel by the thus molten thermoplastic material,
   the method being characterized in that the sealed fluidic channel is further cut within the molten thermoplastic material such that it is separated into two detached fluidic channel sections, wherein at least one of which is sealed from at least one side by at least a part of the molten thermoplastic material.

### BRIEF DESCRIPTION OF FIGURES

For a fuller understanding of the nature of the present invention, reference is made to the following detailed description taken in conjunction with the accompanying drawings in which:

FIG. 1: shows and example of a fluidic assembly (diagnostic cartridge) which can be sealed and cut by the device or method according to the present invention;

FIG. 2: shows in more detail a piece (PCR disc) of the fluidic assembly of FIG. 1, which harbors the fluidic path to be sealed and cut;

FIG. 3: shows a simple manually-operable embodiment of the device according to the invention with a loaded fluidic assembly of FIG. 1 ready to be sealed and cut;

FIG. 4: schematically shows the principle of sealing and cutting fluidic channels of a fluidic assembly in the embodiment of the device of FIG. 4; A) shows the device in a cartridge loading position of said embodiment, whereas B) shows it in sealing position;

FIG. 5: schematically shows a close-up of a part of the PCR disc of the fluidic assembly of FIG. 2, sealed by a molten piece of thermoplastic material and cut by the device of the invention;

FIG. 6: in A) shows photography of a PCR disc sealed according to the invention, and in B) photography of a PCR disc sealed and cut according to the invention; “L” indicates colored liquid locked in the PCR chambers (203) as a result of sealing;

FIG. 7: shows position of a fluidic assembly in a manipulation compartment of a second embodiment of the device of the invention, capable of ejecting PCR disc from the fluidic assembly, followed by its sealing and cutting from the remaining part of the fluidic assembly in an automated manner;

FIG. 8: shows consecutive steps of sealing and cutting of a PCR disc from a fluidic assembly inside of the manipulation compartment of the device embodiment in FIG. 7; A) shows starting position and engagement of manipulation arrangement with the cartridge; B) shows the action of the manipulation arrangement causing ejection of the PCR disc; C) shows the engagement of a heating blade with a zone of the PCR disc to be sealed and cut; D) shows detached the sealed and cut PCR disc positioned in an accepting tray;

FIG. 9: shows external view of the automated device embodiment of FIGS. 7 and 8; wherein A) shows loading of the fluidic assembly into the device; B) shows loading of an accepting tray into the device; C) shows removal of the accepting tray containing a sealed and cut PCR disk detached from the loaded fluidic assembly; and D) shows the ejection of the remaining part of the fluidic assembly ready to be dispensed with;

FIG. 10: shows an alternative design for the automated device embodiment of FIGS. 9 and 10, wherein A) shows election of the sealed and cut PCR disk and B) shows ejection of the remaining part of the fluidic assembly ready to be dispensed with.

### DETAILED DESCRIPTION OF THE INVENTION

The present invention solves the problem of storing degradable biological fluids in multi-component and potentially bulky disposable fluidic arrangements, by allowing to lock (seal) and separate (cut out) in a contamination-free manner the fluid of interest in a predefined zone of a fluidic path. The present device achieves the above by melting a thermoplastic material contained in this path and, as a consequence, by sealing the path with the molten thermoplastic thus preventing potential evaporation or fluid escape issues; and then by employing cutting means to cut in a spillage- and contamination-free manner within the thus formed seal.

In general, the present device concerns a device for sealing and cutting through a fluidic path in a fluidic assembly, said device comprising:
a manipulation compartment (101) for holding
a fluidic assembly (2) comprising at least one fluidic channel (201a) forming a path for fluidic flow and comprising a thermoplastic zone (201b), further referred to as a thermoplastic fluidic channel zone (201b), comprising a thermoplastic material meltable when exposed to a temperature equal or above a threshold temperature specific to said thermoplastic material; and
a heating element (102) positioned in or capable of entering into the manipulation compartment (101) and capable of producing temperature equal to or above said threshold temperature;
   wherein the device (100) is configured such that when the fluidic assembly (2) is provided in the manipulation compartment (101), the heating element (102) accesses and heats at least a part of the thermoplastic fluidic channel zone (201b) for a time sufficient to melt the thermoplastic material comprised in said heated part and to seal the fluidic channel (201a) by the thus molten thermoplastic material (201c);
   the device characterized in that the device (100) comprises a cutting element (104) configured to cut the sealed fluidic channel (201a) within the molten thermoplastic material (201c).

As used herein, the term “fluidic assembly” is to be understood as a self-contained assembly comprising at a series of chambers and/or channels being in fluid communication with each other and thus forming a fluidic path suitable for flow of a fluid such as liquid. An example of a fluidic assembly is a “fluidic cartridge” which can be defined as a fluidic assembly formed as a single object that can be transferred or moved as one fitting inside or outside of a larger instrument suitable for accepting or connecting to such cartridge. Some parts contained in the cartridge may be firmly connected whereas others may be flexibly connected and movable with respect to other components of the cartridge. As used herein the term “fluidic cartridge” shall be understood as a cartridge including at least one fluidic path formed by a series or ducts, channels, dead-end channels or chambers suitable for treating, processing, discharging, or analyzing a fluid, preferably being a liquid.

As used herein, especially in the context of sealing and cutting, the term “fluidic channel” is to be understood as any section of a fluidic path within a fluidic assembly to which a fluid can enter or through which a fluid can pass, irrespective of its shape and amount of entry points connected to said section. In this meaning, as used herein by “sealing and cutting a fluidic channel” it is to be understood as sealing and cutting any section of a fluidic path such as a duct having at least two or more entry points but also a dead-end channel or a chamber which communicates with the fluidic path through only one entry point.

Depending on the diameter of fluidic channels, a fluidic cartridge could also be referred to as a “microfluidic cartridge”. In general, as used herein the terms “fluidic”, “microfluidic”, or “(micro)fluidic” are to be interpreted as synonymous and shall refer to systems and/or arrangements dealing with the behavior, control, and manipulation of fluids that are geometrically constrained to a small, typically sub-millimeter-scale in at least one or two dimensions (e.g. width and height or a channel). Such small-volume fluids are moved, mixed, separated or otherwise processed at micro scale requiring small size and low energy consumption. (Micro)fluidic systems include structures such as micro pneumatic systems (pressure sources, liquid pumps, micro valves, etc.) and structures like channels or chambers for the handling of mili-, micro-, nano- and picoliter volumes. In the context of fluid flow in fluidic assemblies or cartridges, the terms “downstream” and “upstream” can be defined as relating to the direction in which fluids flow in a provided fluidic path. Namely, the section in a fluidic path from which a fluid flows towards a second section of the same path is to be interpreted as positioned upstream of the latter. Analogously, the section to which a fluid arrives later is to be interpreted as positioned downstream with respect to a section which said fluid passed earlier.

Due to their unprecedented ease of use, speed in performing diagnostic tests and other advantages, use of fluidic or microfluidic cartridges is becoming a standard in diagnostics. Examples of such assemblies can be found in EP1896180, EP1904234, and EP2419705. Such and other (micro)fluidic diagnostic cartridges frequently comprise diagnostic tests that are based on polymerase chain reaction (PCR) that amplifies one or more target DNA molecules to great amounts in order to perform their characterization. A PCR-performing diagnostic cartridge will comprise means for performing PCR such as appropriate primers, buffers, and enzymes etc., and may also be designed to perform other functions such as accepting a biological sample, followed by liberating therefrom nucleic acids necessary for performing a given genetic or diagnostic test, and then providing (e.g. by pumping through fluidic channels of the cartridge) the thus liberated nucleic acids to a compartment suitable for performing the PCR-based assay.

Importantly, any potential escape of the highly PCR-amplified DNA target obtained from one patient can be highly contaminating and should to be prevented not to influence results of diagnostic tests performed on samples obtained from other patients. Therefore, once used, most of the diagnostic cartridges are designed to be safely dispensed with as a whole closed unit harboring the amplified material in the same way as other used disposable laboratory equipment.

For this reason, most parts of diagnostic cartridges are manufactured in standard dispensable laboratory plastic materials, usually being easily moldable thermoplastics such as polystyrene (PS) or polyethylene (PE) or their derivatives. As used herein the term “thermoplastic” shall be understood as denoting a material, such as a synthetic plastic or resin, that can become soft (or melts) when heated to a material-specific melting temperature (Tm), further referred to as the “threshold temperature”, and rehardens on cooling without appreciable change of properties. Examples of thermoplastics are well known in the art of manufacturing laboratory equipment or diagnostic cartridges and include the afore-mentioned polystyrene (PS) or polyethylene (PE, including its different subtypes like high-density polyethylene (HDPE), medium-density polyethylene (MDPE), low-density polyethylene (LDPE), or cross-linked polyethylene known as “PEX”), polypropylene (PP), but also polyesters (PET, PBT, or PETP), polycarbonate (PC), polyether sulfone (PES), polyetherimide (PEI), polybenzimidazole (PBI), olylactic acid (polylactide or PLA), poly(methyl methacrylate) (PMMA), acrylonitrile butadiene styrene (ABS), polyether-ether ketone (PEEK), polyvinyl chloride (PVC), polyphenylene oxide (PPO), or nylon.

However, as there sometimes may arise a need to retrieve from the cartridge either the amplified material (e.g. for performing a diagnostic follow up via its sequencing) or whatever remains from the fed thereto biological sample or purified therefrom nucleic acids (e.g. for redoing the diagnostic test or performing other tests), many diagnostic laboratories may consider to store or transport the used cartridges before deciding to safely dispose them, in which case the retrieval of the biological material of interest would become necessary for a diagnostic follow-up of a patient.

As used herein, the term “biological material of interest” or “biological fluid of interest” is to be understood as a biological molecule (e.g. nucleic acid) containing fluid to be sealed within the fluidic assembly or cartridge by the device of the present invention for the purpose of its further storage, transport, or retrieval. For example, in most common embodiments, the “biological material of interest” or “biological fluid of interest”, depending on the further intentions of the user, can either be a solution comprising PCR-amplified target nucleic acid, a solution comprising nucleic acid purified from a biological sample, or whatever remained from the biological sample initially fed into the fluidic assembly. In contrast, as used herein, the term “biological sample” or simply “sample”, is intended to include a variety of biological sources that contain nucleic acid and/or cellular material, irrespective whether it is freshly obtained from an organism (i.e. fresh tissue sample) or preserved by any method known in the art (e.g. an FFPE sample). Examples of biological samples include: cultures of cells such as mammalian cells but also of eukaryotic microorganisms, body fluids, body fluid precipitates, lavage specimen, fine needle aspirates, biopsy samples, tissue samples, cancer cells, other types of cells obtained from a patient, cells from a tissue or in vitro cultured cells from an individual being tested and/or treated for disease or infection, or forensic samples. Non-limiting examples of body fluid samples include whole blood, bone marrow, cerebrospinal fluid (CSF), peritoneal fluid, pleural fluid, lymph fluid, serum, plasma, urine, chyle, stool, ejaculate, sputum, nipple aspirate, saliva, swabs specimen, wash or lavage fluid and/or brush specimens.

The present device firstly allows sealing of selected liquid contents within a thermoplastic material-containing fluidic path in a fluidic assembly provided to the device's manipulation compartment. Depending on the type of the cartridge, exposing of the thermoplastic fluidic channel zone to the heating element of the present device may have to be aided by a user who provides the fluidic assembly into the manipulation compartment. For example, for some cartridges it may as simple as removing a part of the cartridge's casing (e.g. a lid) thus exposing the fluidic channels and chambers that form the fluidic path to be sealed. In such case, the thus opened cartridge is simply placed in the manipulation compartment of such embodiment of the present device, wherein a heating element positioned in or capable of entering into said manipulation compartment accesses or simply enters into contact with the part of the thermoplastic fluidic channel zone to be sealed within the opened assembly, and starts heating it until the seal is made and the fluid of interest is immobilized within the thus sealed compartment.

Of course, depending on the compartment where the biological material of interest is stored, more than one seal may have to be formed within the fluidic channel forming part of a path for fluidic flow. For example, if the biological material of interest is confined to a chamber connected by only one entry point to said path of fluidic flow, only one seal may be needed to seal the channel leading to or forming said only one entry. However, should the biological material of interest reside within a fluidic assembly in a part of a duct or a chamber through which the fluidic path passes, i.e. having at least two entry points, i.e. at least one upstream and the other one downstream of said part of a duct or a chamber to be sealed, at least two seals may have to be formed by means of the device's heating element or elements, in order to seal such part of a duct or a chamber. Analogously, depending on the shape of said duct or chamber, 3, 4, or more seals may have to be formed.

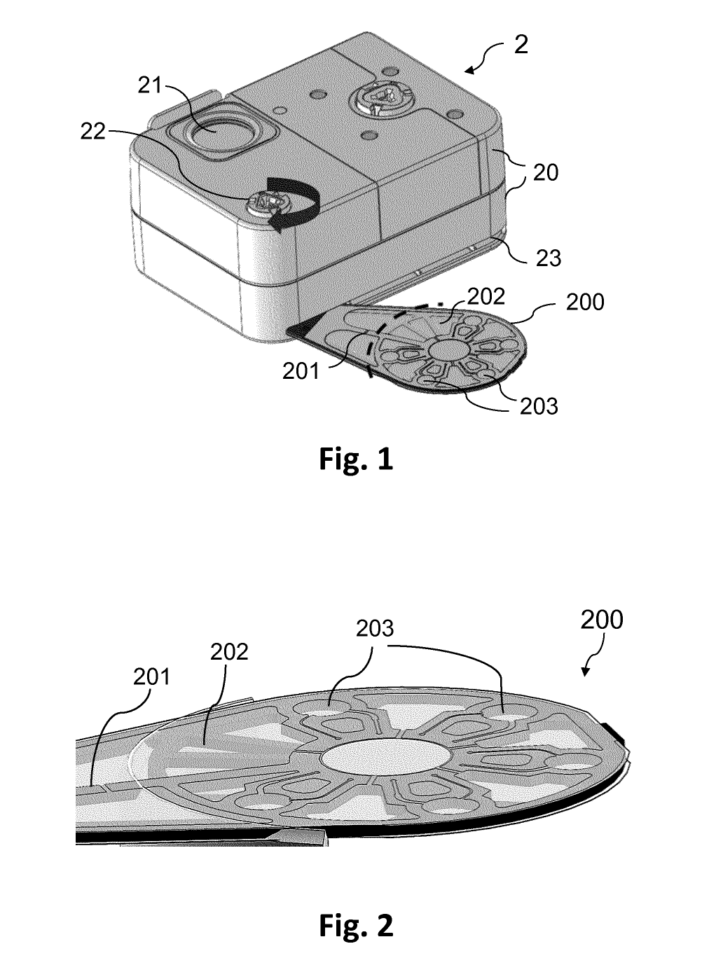

For cartridges of a more sophisticated design, it may be possible to simply induce ejection of an element comprising the part of the fluidic path to be sealed such that the integrity of the cartridge' casing remains intact and the thermoplastic fluidic channel zone becomes readily accessible from outside of the cartridge. An example of such designed diagnostic (micro)fluidic diagnostic cartridge as manufactured by Biocartis NV is schematically shown in FIG. 1. The major part of the sample-to-PCR-result processing fluidic path of the shown cartridge (2) is hidden in the cartridge casing (20). This fluidic path starts in the sample accepting compartment (21), where a biological sample can be provided, and leads through a series of channels and chambers where consecutive steps of nucleic acid purification and processing are performed. In this cartridge design, the purified nucleic acids are pumped into PCR chambers (203) positioned on a PCR disc (200) that can be slid outside of the cartridge via a slit (23) provided in the casing (10) as a result of turning (cf. arrow in FIG. 1) a knob (22) positioned on the cartridge.

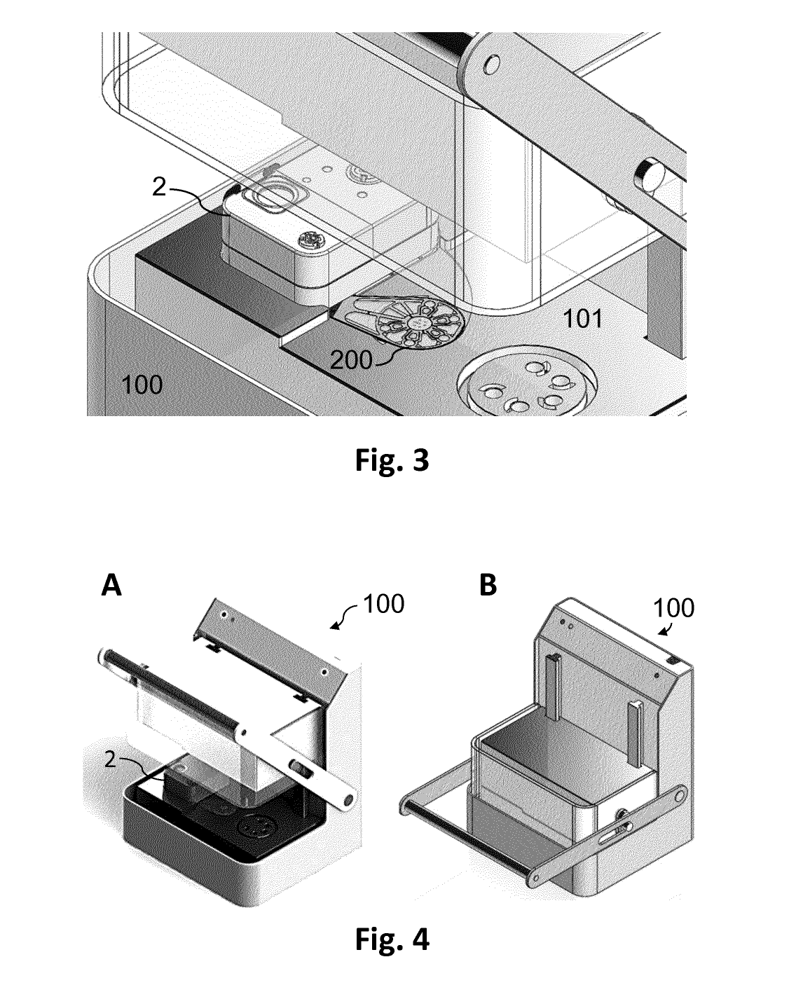

In the above-described cartridge, nucleic acids extracted from the sample inside of the cartridge body are pumped into the PCR chambers (203) in the PCR disc (200) through a channel formed between the PCR disc's thermoplastic backbone (201) and a transparent film (202) that welded to the former from both sides, which is schematically shown in FIG. 2. For example, a user desiring to secure or retrieve the contents of the PCR chambers (203), instead of manipulating the cartridge's casing (20) may simply eject the PCR disc (200) outside of the cartridge (2) via a slit (23) in the casing (20) by simply turning the knob (22). Such manufactured cartridge (2) can be readily placed in one possible embodiment of the present device as schematically shown in FIGS. 3 and 4.

FIG. 3 shows a cartridge (2) with an ejected PCR disc (200) positioned in a manipulation compartment (101) of the device (100) open in a loaded position, as also shown in FIG. 4A. Inside of the manipulation compartment (102), just above the ejected PCR disc (200) resides a heating element (not shown) that will come into contact with the thermoplastic substrate of the PCR disc once the manipulation compartment (101) is closed by the user to the sealing position, as shown in FIG. 4B.

The heating element can be of any type known in the art to achieve temperatures suitable for melting selected thermoplastic materials. Typical examples include a heated wire, a block of metal, a laser, a source of sonication energy, or even a heated blade capable of separating the molten thermoplastic material once it sealed the lumen of the fluidic channels. The heating can be provided directly onto the zone to be sealed, i.e. enter with it in direct contact, or can be focused on it from a distance, for example by means of radiation or a laser beam. In both of these modes, the heating can be provided continuously or in pulses that can either be of constant or variegated intensity and/or frequency.

In a preferred embodiment, the heating element comprises the cutting element. Both elements can be provided as a one two-part element, for example a single component comprising both heating and cutting means, or, alternatively, the heating element can also perform the cutting function by being configured to cut the sealed fluidic channel within the molten thermoplastic material. In the latter case and in a particularly preferred embodiment, the heating element is de facto provided as a cutting element that is heated or produces heat, e.g. comprises at least one heated blade, or a sharp wire, or is a laser powerful enough to cut through and separate from the reminder of the fluidic assembly the heat-sealed zone comprising the fluidic channel with the fluid of interest. Alternatively, a separate cutting element can also be heated or configured to produce heat in addition to the heating element.

In one preferred embodiment, a heated blade is provided that is sufficiently sharp to cut the fluidic channel or the fluidic assembly element that harbors it (such as the PCR disk described above) immediately after the seal is applied. Such blade could be configured to perform a pressure cut or a slicing cut. Alternatively, an additional blade can be provided for engaging with said fluidic channel or element after the seal was applied e.g. in a scissor-like cutting movement. In a preferred embodiment, the heating element comprising the cutting element is configured to cut the sealed fluidic channel within the molten thermoplastic material. The embodiment of the device as shown in FIGS. 3 and 4 can either comprise a heating element that also performs a cutting function, or can simply include a separate cutting element that engages with and cuts through the PCR disc within the sealed zone or just upstream its position.

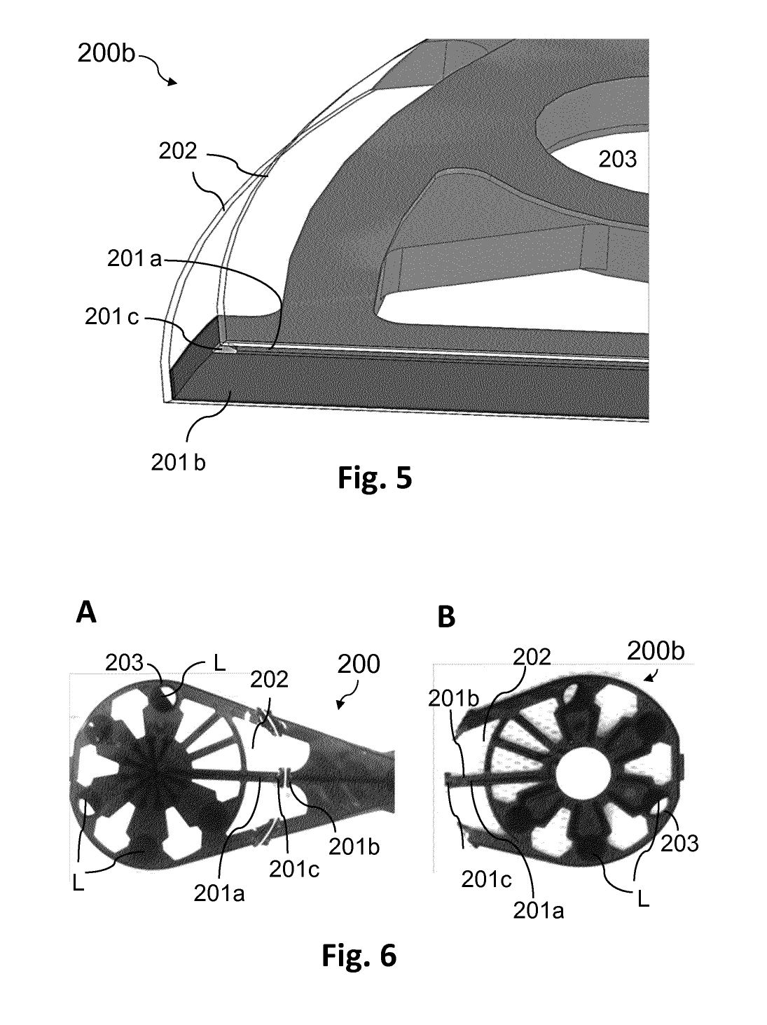

A detailed view of a piece of a cut PCR disk (200b) that is sealed, cut within the formed seal, and separated from the rest of the cartridge is schematically represented in FIG. 5 showing a cross-section through a fluidic channel (201a) formed by a groove in the thermoplastic substrate (201b) of the PCR disc's thermoplastic backbone (201; FIGS. 1 and 2), and by one of the two transparent foils (202) welded onto the thermoplastic backbone from both of its sides. The piece of the molten thermoplastic material (201c) that seals the channel (201a) is indicated in lighter color.

Cutting the sealed part from the rest of the fluidic assembly solves the problem of storing bulky fluidic arrangements and affords for more effective freezing of fluids contained in the sealed and cut part. Achieving an effective and contamination-free sealing and cutting action will naturally depend on the materials used in a given fluidic assembly. Major factors to be considered by a skilled person for fine-tuning the action of sealing and cutting are temperature or temperature ranges to apply to a given thermoplastic material, time over which these temperatures are applied, choice of seal location, pressure in the fluidic channel, geometry and structure of the cutting element, its exertion force, and the desired depth of the seal to be formed. In a preferred embodiment the cutting element is selected from a group comprising at least one blade, a wire, or a laser.

Metal blades are particularly preferred as they can also be easily heated; they can be provided in any shapes or modes of action. This can include a straight, angled (“guillotine”-like), diamond- or trapezoid-shaped or otherwise pointed blade that is pushed downwards, a circular or a rotating cutter (resembling a “pizza cutter”), or a singular or a double (i.e. cutting from both sides) blade that actuates a gradual or a constant angle of contact cut, etc. Alternatively, a sharp robust heated wire firmly applied into the seal can also perform a clean cutting function. In line with the above, in preferred embodiments of the present device, the heating element comprising the cutting element is selected from a group comprising at least one heated blade or a heated wire.

Due to the fact that fluidic assembly pieces (such as the exemplified here above PCR disc) may contain highly amplified DNA material, the challenge of removing them is to prevent liquid spills. The provided herein two-step approach first involves sealing of the PCR chambers from the rest of the assembly by applying a heat seal, then followed by a cutting step in which the sealed-off chambers are released. To demonstrate the effectiveness of this two-step approach in the device according to the invention, a colored fluid substance was pumped into PCR chambers (203) within a PCR disc (200) contained in a cartridge (2) as manufactured by the applicant. As can be appreciated from FIGS. 1-5, the in this particular cartridge type, the PCR chambers (203) and (micro)fluidic channels that lead to them are formed by laminating a top and a bottom foil (202) on a thermoplastic (preferably polyethylene or polypropylene) backbone (201) of the PCR disc (200). The temperature of the heating element (in this experiment being a heated metal plate) is chosen such that the polyethylene in the thermoplastic backbone (201) is deformed while the top and bottom foils (202) remain intact. The size and the shape of heated metal plate was chosen such that sufficient amount of the thermoplastic material was molten and displaced from the thermoplastic substrate (201b) in order to seal the channels (2). The result of the sealing is shown in FIG. 6A where “L” designates the colored fluid visibly locked in the PCR chambers (203). The effectiveness of the thus applied seal was further tested by applying pressure onto different PCR chambers and monitoring potential fluid discharges from the zone where the channel outlet of the PCR chambers (203) was present. No traces of colored liquid were observed demonstrating that the thus applied seal was leak-proof.

In the next step, a sharp cutting blade having the same shape as the heating metal plate was provided to cut along the sealed zone of the PCR disc in order to physically separate the part of the PCR disc containing the PCR chambers (203) filled with colored liquid (“L”) from the rest of cartridge. The thus cut and sealed PCR disc (200b) is shown in FIG. 6B and was also tested for potential leakages under applied pressure with the result that no leakage was observed. Other shapes of heated blades were also tested at different temperature ranges selected between melting temperatures of the seal-forming thermoplastic polypropylene (Tm=160° C.) of the PCR disc and its protecting PET foil (Tm=255° C.). These included a pointed blade cutting outwards from inside (achieving 48.7 N at blade contact and generating an abrupt cut); scissors-like blades cutting with a high angle of contact (+/−14.6 N at blade contact applied gradually and generating straight and smooth cut); or a paper cutter-like blade arrangement configured to cut at a constant angle of contact (42 N at blade contact—abrupt cut). By appropriately adjusting temperature values, blade application forces, and to some extent also the sealing duration times, satisfactory seal depths could be achieved with no leakages following the separation by cutting.

It should be noted that the present examples of sealing and cutting as performed on the described herein PCR disc (200) serve only as a proof-of-principle of a more general concept conveyed in the preset disclosure and are not limited to sealing of PCR discs of this particular structure. As will be appreciated by any skilled person, the same principles can be applied to seal and separate one or more selected parts of any fluidic assembly containing fluidic channels comprising a thermoplastic material, by adjusting the dimensions of the present device's manipulation compartment to the cartridge of choice, as well as the number, shape, and/or type of its heating and cutting elements and the parameters at which they are configured to work. For example, in possible preferred embodiments and as demonstrated above, the heating element can be selected from a group comprising a heated blade, a heated wire, a laser, and preferably is a heated blade.

In line with the above example, in a particular embodiment, a device can be provided comprising a further additional or separate cutting element (104) positioned in or capable of entering into the manipulation compartment (101) and wherein the cutting of the sealed fluidic channel is done by said cutting element (104), e.g. being an additional, potentially also heated blade. Advantageously however, in a preferred embodiment, a device will be provided wherein the cutting of the sealed fluidic channel is done by the heating element (102), for example being a heated blade or a heated wire, which initiates melting the thermoplastic substrate comprising the channel to be sealed as soon as it enters into contact with said substrate and then separates it from the rest of the assembly by being gradually pushed into the thus formed seal until the substrate is separated into two parts.

In a particularly desired embodiment of the present invention, a device is provided, wherein the cutting of the sealed fluidic channel within the molten thermoplastic material separates the fluidic assembly into at least two detached (or disconnected) from each other pieces, wherein at least one of said pieces, further referred to as the sealed and cut fluidic assembly piece (200b), comprises a section of said cut sealed fluidic channel that is sealed from at least one side by at least a part of the molten thermoplastic material (201c).

In a further preferred embodiment of the present device, in order to further minimize the handing and/or manipulating of the fluidic assembly by the user, a device is provided further comprising a manipulation arrangement positioned in the manipulation compartment for exposing at least the part of the thermoplastic fluidic channel zone to be heated to the heating element. For example, such manipulation arrangement may be capable of removing or opening a part of the external casing of the fluidic assembly e.g. by use of cutting, and/or grabbing means, which can fairly easily be designed and/or made by a skilled person. In case of more sophisticated fluidic assemblies as the one presented above, such manipulation arrangement could be simply designed as an element comprising an extension or a member capable with engaging with the rotatable knob (22) of the cartridge (2), which controls the sliding ejection of the PCR disc (200) through the slit (23) provided in the cartridge casing (20).

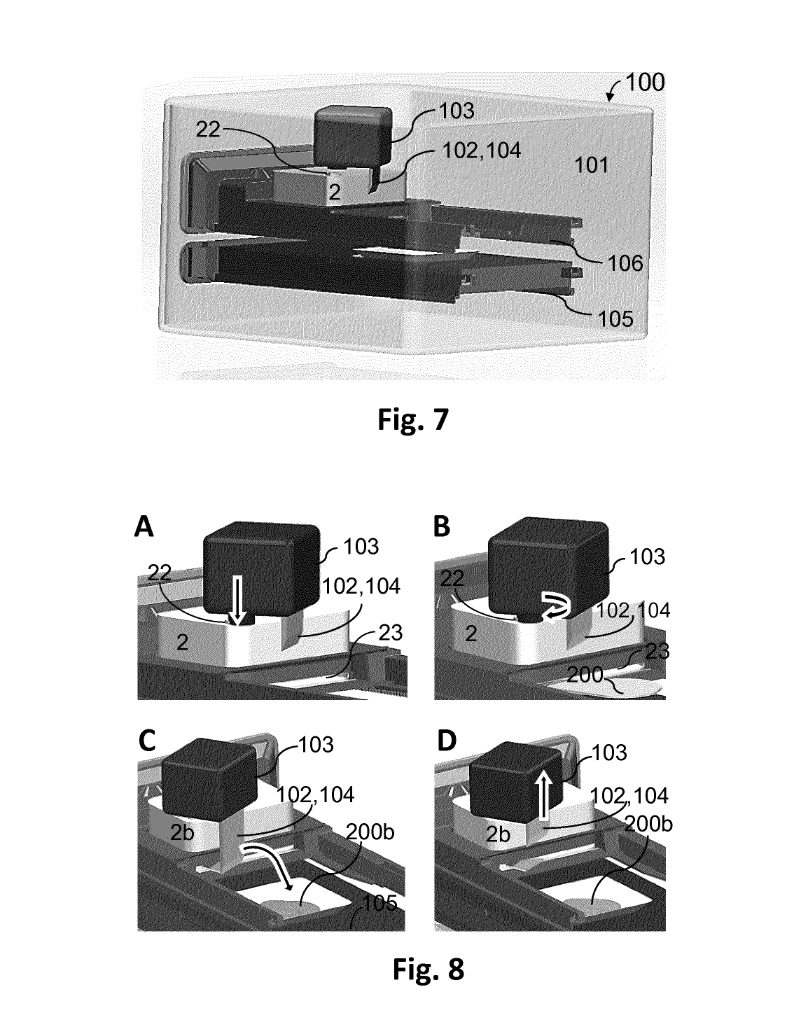

An example of such automated embodiment of the device (100) according to the invention is shown in FIGS. 7-9. In particular, FIG. 7 shows positioning of a fluidic cartridge (2) inside of the device's manipulation compartment (101) just underneath a manipulation arrangement (103) also equipped in a heating blade serving both as a heating element (102) and the cutting element (104), as seen from the behind of this device (100). Initially, the closed cartridge (2) is positioned in an ejectable tray (106) placed above a second ejectable tray (105) which serves to capture the cartridge piece once it is sealed and detached from the remaining part of the cartridge by the present device, and the ejects it to provide it to the user. Such solution affords for a useful functionality, and therefore, in particular embodiments of the present invention, a device is advantageously provided further comprising ejection arrangement (105) that ejects the sealed fluidic assembly piece (200b) from the manipulation compartment (101), preferably from inside of the device.

FIG. 8 shows the consecutive steps of sealing and cutting of the PCR disc (200) from the fluidic assembly (2) as they happen inside of the manipulation compartment (101) as shown in FIG. 7. The sealing-and-cutting process starts with the engagement (symbolized as a downward arrow) of the extension of the manipulation arrangement (103) with the rotable knob (22) of the cartridge (2) (FIG. 8A). Once engaged, the extension of the manipulation arrangement (103) rotates the knob (22), thus causing the ejection of the PCR disc (200) through the slit (23) (FIG. 8B). Once the PCR disc (200) is ejected, the heated blade serving both as the heating and the cutting element (102, 104) engages with the zone of the PCR disc to be sealed and cut (FIG. 8C). Finally, once the sealed and cut PCR disc (200b) is detached from the remaining part of the cartridge (2b), it falls onto the tray (105) serving as an ejection arrangement (FIG. 8D) and can be provided for the user.

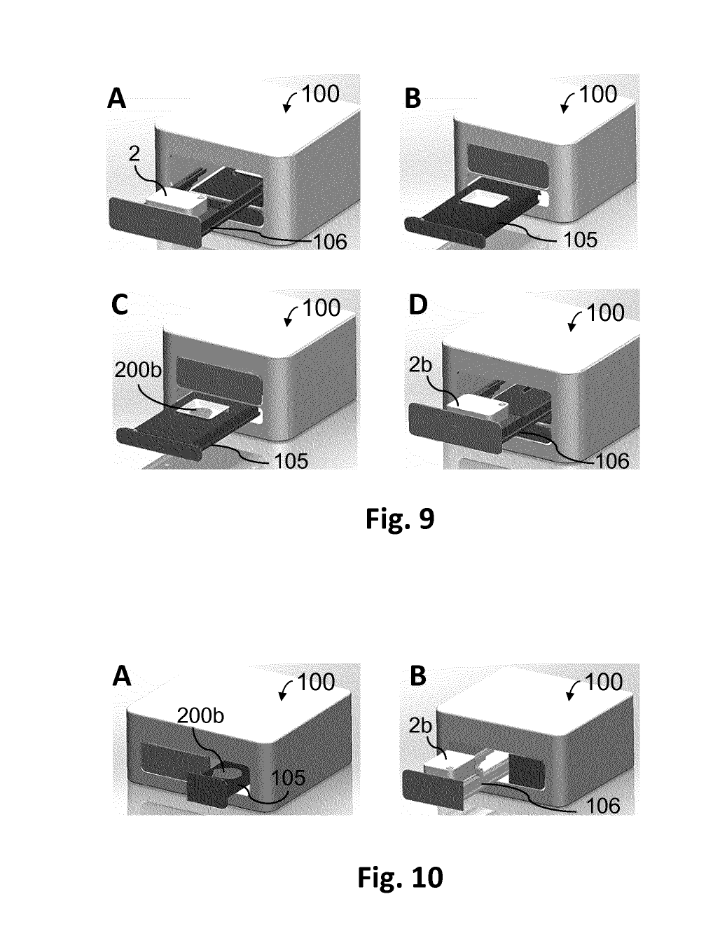

An example of the external design of the above automated embodiment of the device is shown in FIG. 9. The two upper panels show loading of the device before the sealing-and-cutting action including loading of the cartridge (2) (FIG. 9A) and the tray for accepting the cut-and-sealed fluidic assembly piece once the process is over (FIG. 9B). The bottom panel shows the retrieval of the cut-and-sealed fluidic assembly piece (200b) that is ready to be stored or transported (FIG. 9C), and the ejection of the remaining part of the cartridge (2b) with can be dispensed with. An alternative design of a similar device is shown in FIG. 10, also at the stage of the cut-and-sealed fluidic assembly piece (200b) retrieval (FIG. 10A) and ejection of the unnecessary remaining bulk of the cartridge (2b) (FIG. 10B).

There exist other possible modifications that can be introduced to different embodiments of the device according to the invention. For example, a possible embodiment may further comprise a leak testing mode for assessing the strength of the applied heat seal, or a screen allowing to monitor different stages of the sealing process and reporting any potential occurrence of errors by warnings. In a further embodiment, the present device may form part of a larger diagnostic device or a platform that runs tests on diagnostic cartridges. These and other similar modifications will be readily conceivable to be applied by a skilled engineer and will not be elaborated on further in the present disclosure.

In a further aspect, the present invention also provides a method for sealing and cutting through a fluidic path in a fluidic assembly (2), said method comprising the steps of:
providing a fluidic assembly (2) comprising at least one fluidic channel (201a) forming a path for fluidic flow and comprising a thermoplastic zone (201b), further referred to as a thermoplastic fluidic channel zone (201b), comprising a thermoplastic material meltable when exposed to a temperature equal or above a threshold temperature specific to said thermoplastic material;
providing a heating element (102) capable of producing temperature equal to or above the threshold temperature specific to thermoplastic material comprised in the thermoplastic fluidic channel zone; and
providing a localized heating from the heating element (102) to at least a part of the thermoplastic fluidic channel zone (201b) for a time sufficient to melt the thermoplastic material comprised in said heated part and to seal said fluidic channel (201a) by the thus molten thermoplastic material (201c).
   the method characterized in that the sealed fluidic channel (201a) is further cut within the molten thermoplastic material (201c) such that it is separated into two detached fluidic channel sections, wherein at least one of which is sealed from at least one side by at least a part of the molten thermoplastic material (201c)

In a particular embodiment, a method is also provided further comprising the step of mechanically manipulating the fluidic assembly to directly expose the thermoplastic fluidic channel zone (201b) to the heating element (102) in order to be thereby heated and sealed to the heating element (102), and then further cut.

In another embodiment, a method of the invention is provided wherein the cutting the sealed fluidic channel separates the fluidic assembly (2) into at least two pieces, wherein at least one of said pieces, further referred to as the sealed and cut fluidic assembly piece (200b), comprises the section of said cut sealed fluidic channel that is sealed from at least one side by at least a part of the molten thermoplastic material (201c) that was molten by the heating element (102).

In a particular aspect, the present invention also concerns a method in accordance with the above method embodiments, preceded by a step of running an assay in the fluidic assembly (2), and then followed by a step of performing a second assay using the fluid sealed in the fluidic channel (201a) or upstream of said fluidic channel (201a), preferably also comprising the step of retrieving said fluid from the sealed fluidic channel (201a) or any compartment positioned upstream therefrom and sealed by the molten thermoplastic material (201c). In line with the above, in another preferred embodiment of the present method, the fluidic assembly (200) is a diagnostic cartridge.

In a further embodiment a method is provided, wherein the heating element (102) is selected from a group comprising at least one heated blade, a heated wire, or a laser, and preferably is the element that performs the cutting within the molten thermoplastic material.

Further, in another advantageous embodiment, a method is provided wherein the thermoplastic material comprised in the thermoplastic fluidic channel zone is selected from PE, LDPE, HDPE, PET, PP, PPO, PS, PC, PES, PEI, PBI, PLA, PMMA, ABS. In another preferred embodiment of the above embodiment, the fluidic channel zone is built up from at least two different materials with different melting temperatures, wherein said materials are arranged in a composite structure and the material directly exposed to the heating element has Tm₁>Tm₂ of the material further removed from the heating element. As demonstrated in the examples above, such arrangement allows to effectively melt the thermoplastic material of the channels (as above exemplified by PP) having a lower Tm than the Tm of the material of the external foil (as above exemplified by PET). In the above examples, the sealing temperature of the heating element was selected such that it was higher than the Tm of the thermoplastic material forming the seal (as exemplified by the PP forming the channels of the PCR disc), and at the same time lower than the Tm of the material external to the one forming the seal (above exemplified by the PET foil protecting the PCR disc). For PET and PP, the best results were obtained for different heated blades brought to temperatures between 200° C. till 220° C., preferably about 209° C. (about 210° C.). Such adjusted sealing and cutting conditions allowed keeping the heating element clean from any molten thermoplastic residues and thus ready for an immediate next sealing/cutting action.

Lastly, in a particularly preferred embodiment, the method of the invention is performed on the device according of the invention and most preferably is fully automated.

1. A device for sealing and cutting through a fluidic path in a fluidic assembly, said device comprising:
a manipulation compartment for holding a fluidic assembly having (i) at least one fluidic channel forming a path for fluidic flow and (ii) a thermoplastic fluidic channel zone comprising a thermoplastic material that is meltable when exposed to a temperature equal to or above a threshold temperature specific to said thermoplastic material; and
a heating element positioned in or capable of entering into the manipulation compartment and capable of producing the temperature equal to or above said threshold temperature specific to said thermoplastic material;
wherein the device is configured such that when the fluidic assembly is provided in the manipulation compartment, the heating element heats at least a part of the thermoplastic fluidic channel zone for a time sufficient to melt the thermoplastic material in said heated part of the thermoplastic fluidic channel zone and to seal the at least one fluidic channel by the thus molten thermoplastic material; and
a cutting element configured to cut the at least one fluidic channel sealed within the molten thermoplastic material.

2. The device according to claim 1, wherein the cutting element is selected from a group comprising: at least one blade, a wire, or a laser.

3. The device according to claim 1, wherein the cutting element is also heated or produces heat.

4. The device according to claim 1, wherein the heating element includes the cutting element.

5. The device according to claim 4, wherein the heating element including the cutting element is configured to cut the at least one fluidic channel sealed within the molten thermoplastic material.

6. The device according to claim 5, wherein the heating element including the cutting element is selected from a group comprising: at least one heated blade or a heated wire.

7. The device according to claim 1, wherein said cutting element cuts the at least one fluidic channel sealed within the molten thermoplastic material to separate the fluidic assembly into at least two pieces detached from each other, wherein at least one of said pieces is a sealed fluidic assembly piece comprising a section of said cut sealed fluidic channel that is sealed from at least one side by at least a part of the molten thermoplastic material.

8. The device according to claim 7, further comprising an ejection arrangement that ejects the sealed fluidic assembly piece from the manipulation compartment.

9. A method for sealing and cutting through a fluidic path in a fluidic assembly, said method comprising the steps of:
providing a fluidic assembly having (i) at least one fluidic channel forming a path for fluidic flow and (ii) a thermoplastic fluidic channel zone comprising a thermoplastic material that is meltable when exposed to a temperature equal to or above a threshold temperature specific to said thermoplastic material;
providing a heating element capable of producing the temperature equal to or above the threshold temperature specific to said thermoplastic material; and
locally heating at least a part of the thermoplastic fluidic channel zone with the heating element for a time sufficient to melt the thermoplastic material to seal the at least one fluidic channel by the thus molten thermoplastic material;
cutting the at least one sealed fluidic channel within the molten thermoplastic material such that it is separated into at least two fluidic channel sections detached from each other, wherein at least one of the fluidic channel sections is sealed from at least one side by at least a part of the molten thermoplastic material.

10. The method according to claim 9, further comprising mechanically manipulating the fluidic assembly to directly expose the thermoplastic fluidic channel zone to the heating element in order to be heated and sealed.

11. The method according to claim 9, wherein the cutting of the at least one sealed fluidic channel separates the fluidic assembly into at least two pieces, wherein at least one of said pieces is a sealed fluidic assembly piece comprising the section of said cut sealed fluidic channel that is sealed from at least one side by at least a part of the molten thermoplastic material.

12. The method according to claim 9, wherein
the heating element is selected from a group comprising: at least one heated blade, a heated wire, or a laser, and
the heating element performs the cutting within the molten thermoplastic material.

13. The method according to claim 9, wherein said thermoplastic material is selected from: PE, LDPE, HDPE, PET, PP, PPO, PS, PC, PES, PEI, PBI, PLA, PMMA, and ABS.

14. The method according to claim 9, wherein said method is automated.

15. The method according to claim 9, wherein the fluidic assembly is a diagnostic cartridge.
